(19) United States
(12) Patent Application Publication
(10) Pub. No.: US 2011/0282923 A1
(43) Pub. Date: Nov. 17, 2011

(54) FILE MANAGEMENT SYSTEM, METHOD, AND RECORDING MEDIUM OF PROGRAM

(75) Inventors: Tetsutaro MARUYAMA, Kawasaki (JP); Yoshitake Shinkai, Kawasaki (JP); Takeshi Miyamae, Kawasaki (JP); Kensuke Shiozawa, Kawasaki (JP)

(73) Assignee: FUJITSU LIMITED, Kawasaki-shi (JP)

(21) Appl. No.: 13/105,087

(22) Filed: May 11, 2011

(30) Foreign Application Priority Data
May 14, 2010 (JP) 2010-111674

(51) Int. Cl. G06F 17/30

(52) U.S. Cl. 707/827; 707/E17.01

(57) ABSTRACT

A system including computers storing files, a first computer of the computers includes a storage unit to store information about a first directory that includes identification information of a second computer that store information about a second directory or a file under the first directory, and a replying unit to reply, when a request for looking up information about the second directory or the file is received, with the identification information of the second computer stored in the storage unit.

### CROSS-REFERENCE TO RELATED APPLICATIONS

This application is based upon and claims the benefit of priority of the prior Japanese Patent Application No. 2010-111674, filed on May 14, 2010, the entire contents of which are incorporated herein by reference.

### FIELD

The embodiments disclosed herein are related to file management.

### BACKGROUND

An NAS (Network Attached Storage) is a file server apparatus which can be used by being connected to a network. One of characteristics of the NAS is that a client apparatus of the NAS can use a data storage region included in the NAS (server) as if the data storage region is incorporated in the client apparatus.

In recent years, various servers have been used as NASs and infrastructures of networks have been improved, and the servers are installed in a space referred to as a “data center” in a concentrated manner. This concentrated installation attains advantages in terms of a power consumption matter, a cooling matter, a data maintenance matter, and the like. The number of servers installed in the data center has been increased as required capacity of the data storage region increases, and accordingly, an enormous number of servers have been installed in the data center.

When the servers are installed in the concentrated manner, an administrator of the data center has to manage the number of servers. If cost of the management can be reduced, such cost is the most meaningful for the installation of the servers in the data center in a concentrated manner. However, in general, a single server (NAS server) serving as an NAS corresponds to a virtual storage (NAS client) of a client on a one-to-one basis as shown in FIG. 1. Therefore, it is difficult to efficiently reduce a management cost merely by concentrating arrangement positions of the servers. Note that examples of the virtual storage of the client include a drive of Windows® (registered trademark). Therefore, a one-to-one correspondence between the server serving as the NAS and the virtual storage means a one-to-one correspondence between a server and a drive, for example.

FIG. 2 illustrates a cluster file system. In the cluster file system, a plurality of servers are virtually shown as a single storage.

FIG. 2A is a diagram illustrating an In-Band cluster file system. In the In-Band cluster file system, an NAS client accesses an NAS server through a meta server. On the other hand, FIG. 2B is a diagram illustrating an Out-of-Band cluster file system. In the Out-of-Band cluster file system, a meta server is arranged out of a path which connects an NAS client and an NAS server. Note that the meta server integrally manages meta information of file systems of a plurality of NAS servers. The meta information includes information representing locations of files. Therefore, in the cluster file system, meta information integrally managed by the meta server is used to specify one of the NAS servers which includes a file to be operated by the NAS client.

However, there arises a problem in that capacity of the cluster system for a number of servers to be virtually integrated (that is, scalability) depends on a design of the meta server. That is, the number of NAS servers which can be integrated is limited in accordance with the design of the meta server.

### SUMMARY

According to an aspect of the invention, a system including computers storing files, a first computer of the computers includes a storage unit to store information about a first directory that includes identification information of a second computer that stores information about the second directory or the file under the first directory; and a replying unit to reply, when a request for looking-up information about the second directory or the file is received, with the identification information of the second computer stored in the storage unit.

The object and advantages of the invention will be realized and attained by at least the elements, features, and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 illustrates the relationship between a client and a server in an NAS in the related art;

FIG. 2A illustrates an example of a configuration of a cluster system in the related art (In-Band Method);

FIG. 2B illustrates an example of a configuration of a cluster system in the related art (Out-of-Band Method);

FIG. 3 illustrates an example of a configuration of a file management system;

FIG. 4 illustrates a hardware configuration of a server apparatus;

FIG. 5 illustrates configurations of functions of an L7 switch, a server unit, and a monitoring unit;

FIG. 6A schematically illustrates a system of name information and file bodies;

FIG. 6B schematically illustrates a system of name information and file bodies;

FIG. 7 illustrates name information associated with a directory;

FIG. 8 illustrates a processing procedure when a server apparatus is newly activated;

FIG. 9 illustrates a configuration of a server list storage unit;

FIG. 10 illustrates a processing procedure when an existing server apparatus is activated;

FIG. 11 illustrates a processing procedure of a heart beat communication;

FIG. 12 illustrates a processing procedure of a file generation process;

FIG. 13 illustrates a configuration of a file descriptor according to an embodiment;

FIG. 14 illustrates a processing procedure of a process of obtaining the file descriptor; and

FIG. 15 illustrates a processing procedure of a file generation process when a file descriptor of a parent directory has been cached.

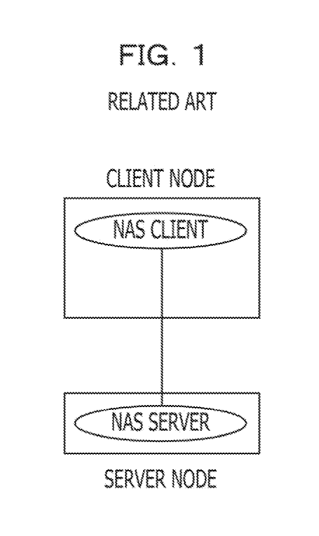

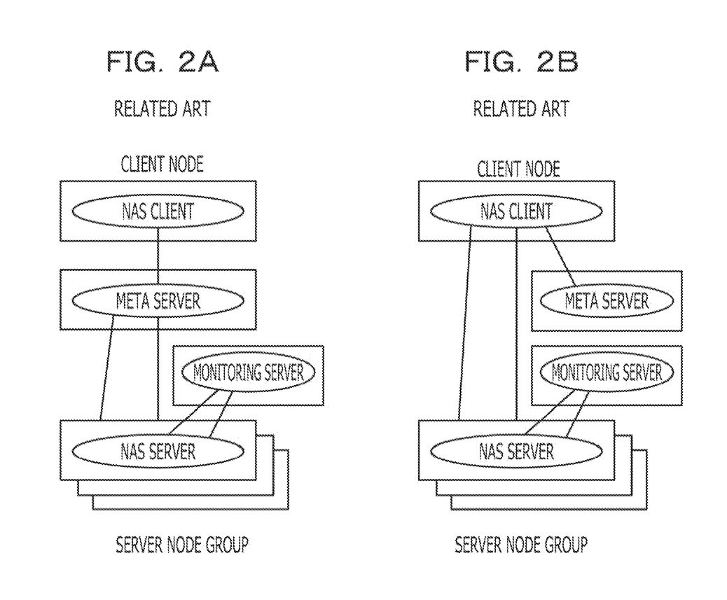

### DESCRIPTION OF EMBODIMENTS

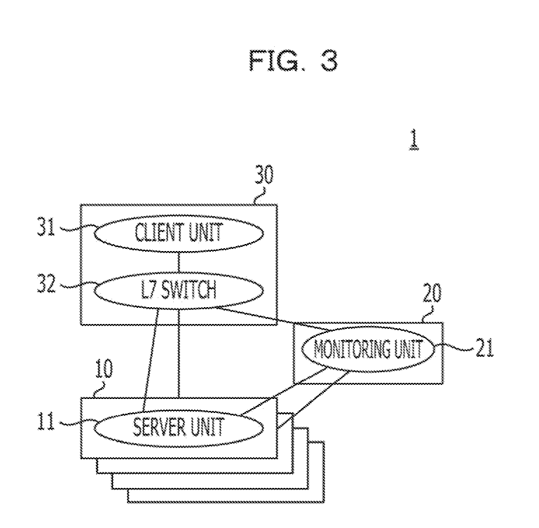

Embodiments of the present invention will be described hereinafter with reference to the accompanying drawings. FIG. 3 is a diagram illustrating a configuration of a file management system according to an embodiment of the present invention. In FIG. 3, a file management system 1 includes a plurality of server apparatuses 10, a monitoring apparatus 20, and one or more client apparatuses 30. The apparatuses included in the file management system 1 can communicate with one another through a network such as a LAN (Local Area Network), the Internet, or the like (a wired network or a wireless network).

The server apparatuses 10 are so-called NAS (Network Attached Storage) servers and store (manage) file groups which store data. In this embodiment, a plurality of server apparatuses 10 manages files in a distribution manner. Specifically, the server apparatuses 10 are examples of file management apparatuses in this embodiment. Each of the server apparatuses 10 includes a server unit 11. The server unit 11 systematically realizes a function of systematically managing files.

The monitoring apparatus 20 is a computer which monitors a state of the server apparatuses 10. The monitoring apparatus 20 includes a monitoring unit 21. The monitoring unit 21 monitors states of the server apparatuses 10 and manages a list of server apparatuses 10 operating normally.

The client apparatuses 30 are computers which use the files managed by the server apparatuses 10. Each of the client apparatuses 30 includes a client unit 31 and an L7 switch 32. The client unit 31 uses the files managed by the server apparatuses 10.

The L7 switch 32 is an example of relaying mechanism and realizes a virtual network switch. The L7 switch 32 virtualizes the plurality of server apparatuses 10 as a single server apparatus. Specifically, the L7 switch 32 is seen as a single server apparatus by the client unit 31. As a result, the client unit 31 can use files included in the server apparatuses 10 in a distributed manner in accordance with a conventional NAS protocol without taking the presence of the plurality of server apparatuses 10 into consideration. Note that examples of the conventional NAS protocol include an NFS (Network File System) or a CIFS (Common Internet File System).

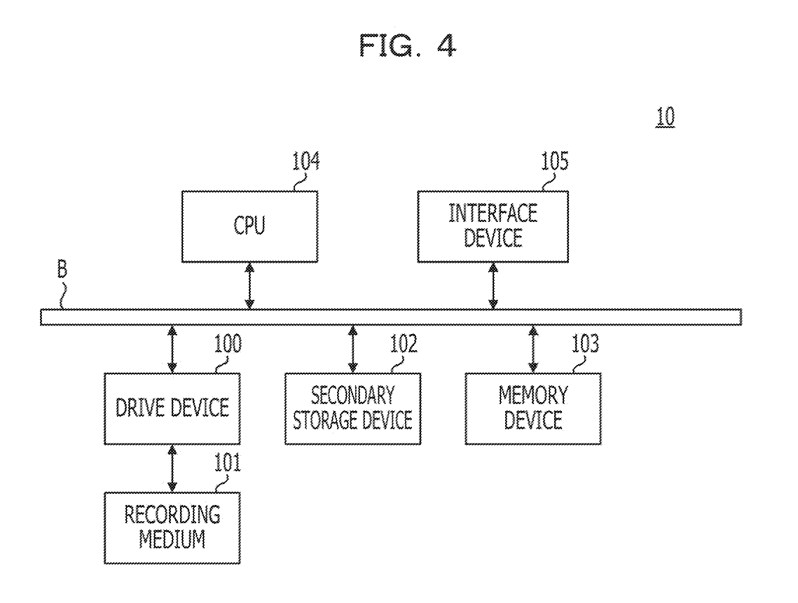

FIG. 4 is a diagram illustrating a hardware configuration of one of the server apparatuses 10 according to the embodiment of the present invention. The server apparatus 10 shown in FIG. 4 includes a drive device 100, a secondary storage device 102, a memory device 103, a CPU 104, and an interface device 105 which are connected to one another through a bus B.

A program which realizes a process performed by the server apparatus 10 is supplied by a recording medium 101 such as a CD-ROM. When the recording medium 101 which stores the program is set in the drive device 100, the program is installed from the recording medium 101 through the drive device 100 to the secondary storage device 102. Note that it is not necessarily the case that the program is installed from the recording medium 101, and the program may be downloaded from another computer through a network. The secondary storage device 102 stores the installed program and further stores files and the like to be managed.

When activation of the program is instructed, the memory device 103 reads the program from the secondary storage device 102 and stores the program. The CPU 104 executes a function of the server apparatus 10 in accordance with the program stored in the memory device 103. The interface device 105 is used as an interface for connecting to the network.

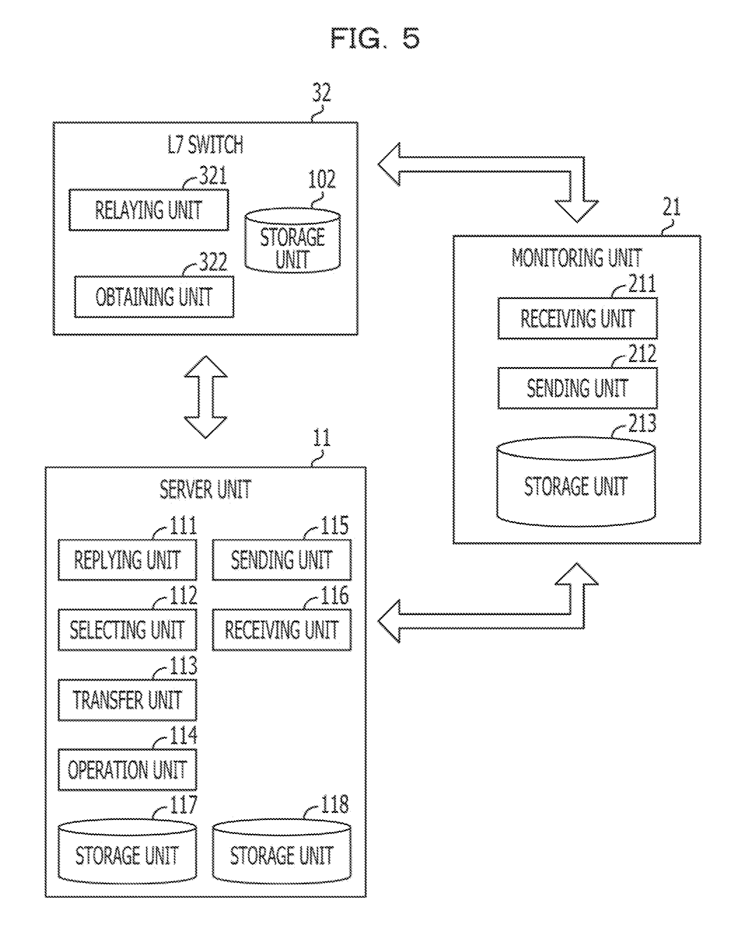

FIG. 5 illustrates configurations of functions of the L7 switch 32, the server unit 11, and the monitoring unit 21.

In FIG. 5, the L7 switch 32 includes a relaying unit 321, an obtaining unit 322, and a storage unit 323. The relaying unit 321 accepts a request for an operation to be performed on files in accordance with the NAS protocol from the client unit 31. The relaying unit 321 determines one of the server apparatuses 10 which is to perform the operation (generating, reading, writing, or the like) and transfers the operation request to the server unit 11 of the server apparatus 10. For the request for operating files transferred to the server unit 11, a file descriptor corresponding to the operation request is specified. The file descriptor (hereinafter referred to as an “FD”) is also called as a file handle in some OSs (Operating Systems) and is generally used as information for specifying a file to be operated. When the operation request represents a generation of a file, an FD of a directory in which a file is to be generated corresponds to the FD corresponding to the operation request. Furthermore, when an operation request corresponds to reading or writing of a file, an FD of a file to be operated corresponds to the FD corresponding to the operation request. Note that “directories” means virtual file-storage areas corresponding to nodes of a tree structure in a case where files are managed by being categorized in the tree structure. The directories are also referred to as folders in some OSs.

The obtaining unit 322 searches for an FD to be used by the relaying unit 321 in accordance with a path name of a directory or a file corresponding to the FD. The storage unit 323 temporarily stores a specified number of FDs used by the relaying unit 321. For example, the storage unit 323 is a storage device included in the client apparatus 30.

The server unit 11 includes a replying unit 111, a selecting unit 112, a transfer unit 113, an operation unit 114, a sending unit 115, a receiving unit 116, a storage unit 117, and a storage unit 118.

The replying unit 111 transmits, in response to a request for obtaining an FD supplied from the obtaining unit 322 included in the L7 switch 32, an FD of a directory or a file corresponding to a path name specified by the obtaining request as a response. The selecting unit 112 serving as an example of a selection mechanism selects, in accordance with a request for generating a file supplied from the relaying unit 321 included in the L7 switch 32, one of the server apparatuses 10 which serves as a file generation destination. The transfer unit 113, serving as an example of a generation-request transfer mechanism, transfers the request for generating a file to the server apparatus 10 selected as the file generation destination. Specifically, in this embodiment, it is not necessarily the case that the server apparatus 10 required to generate a file generates the file corresponding to the generation request in the secondary storage device 102 of the server apparatus 10. The operation unit 114 executes a process in accordance with the request for generating a file which is transferred from the relaying unit 321 or the transfer unit 113 included in the other server apparatus 10. The sending unit 115 periodically transmits a notification (heart beat) representing that the server apparatus 10 has been operating normally to the monitoring apparatus 20 using a communication method generally referred to as a “heart beat communication”. The sending unit 115 includes identification information of the server apparatus 10, statistical information (hereinafter referred to as “data server information”) representing a state of a load, and the like in the heart beat. The receiving unit 116 receives from the monitoring apparatus 20 a response to the heart beat and records list information of the server apparatuses 10 included in the response in the secondary storage device 102.

The storage unit 117 stores file bodies (file entities) assigned to the server apparatus 10 using the secondary storage device 102. The storage unit 118 serving as an example of a location-information storage mechanism stores name information (location information) of directories assigned to the server apparatus 10. Note that the name information of directories means a group of name information (location information) of files included in directories or directories.

In general, in the NAS, three types of information including information on file bodies, information on file attributes, and name information are managed as information associated with files. The file bodies correspond to file entities. The attribute information corresponds to attribute information of files. Examples of the attribute information include a generation date and time, a reference date and time, a data size, and the like. The name information which is expedient information which facilitates management of data performed by users realizes a directory structure and is used to assign path names and file names to files. The name information is managed in a unit of a directory. For example, name information of a certain directory includes information on the directory, information on a parent directory of the directory, and information on a file or a directory located immediately below the directory. Note that the attribute information and the name information are collectively referred to as meta information. Meta information of directories is also managed. As described above, in this embodiment, among the configuration information above, the file bodies are stored in the storage unit 117 and the name information is stored in the storage unit 118.

That is, in this embodiment, the name information is managed separately from the file bodies. The name information is not only managed simply separately from the file bodies, but also managed in the plurality of server apparatuses 10 in a distributed manner.

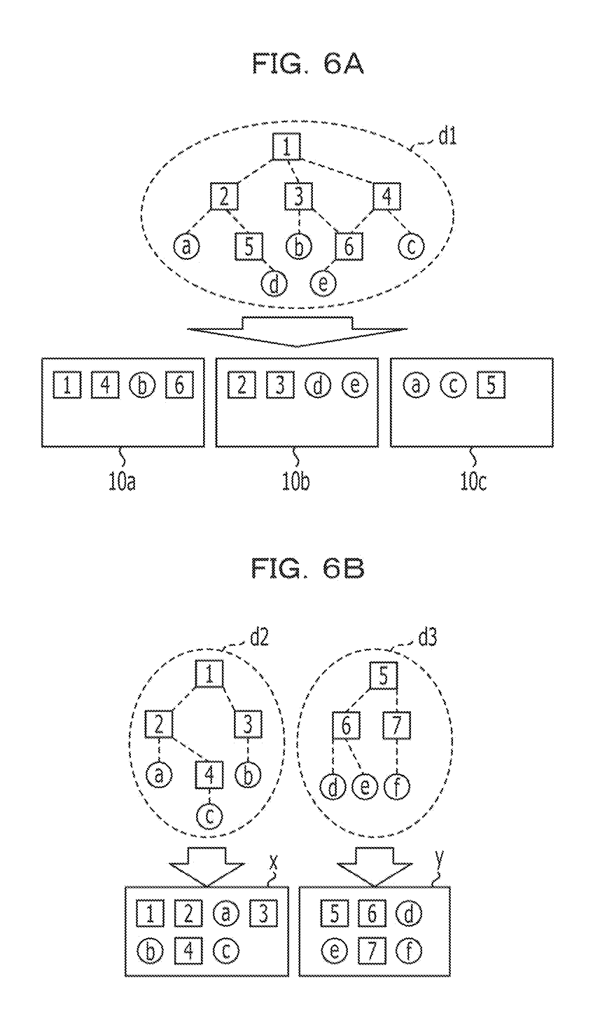

FIGS. 6A and 6B are diagrams schematically illustrating systems for managing name information and file bodies according to this embodiment. In FIG. 6A, “d1” represents a directory structure. Rectangles represent name information of individual directories and circles represent file bodies.

In an example of FIG. 6A, name information of directories 1, 4, and 6 and a file body of a file b are managed by a server apparatus 10a. Name information of directories 2 and 3 and file bodies of files d and e are managed by a server apparatus 10b. Name information of a directory 5 and file bodies of files a and c are managed by a server apparatus 10c. As described above, name information of directories which belong to a single directory structure (a directory structure having a single root directory) is managed by the server apparatuses 10 in a distribution manner irrespective of the parent-child relationships. The term “irrespective of the parent-child relationships” means that it is not necessarily the case that the name information of the directories 2 and 3 which are child directories of the directory 1 is managed by one of the server apparatuses 10 which manages the name information of the directory 1.

On the other hand, FIG. 6B illustrates a management system of name information in a conventional NAS in which client apparatuses correspond to server apparatuses on a one-to-one basis. According to FIG. 6B, name information of directories and file bodies which belong to a single tree structure are managed by the same server apparatus. For example, name information of directories and file bodies which belong to a directory structure d2 are managed by a server apparatus x. On the other hand, name information of directories and file bodies which belong to a directory structure d3 are managed by server apparatus y.

Note that, in this embodiment, the attribute information is managed in association with the file bodies. Specifically, the attribute information is stored in the storage unit 117 in association with the file bodies. This is because the file bodies and the attribute information are used together in many cases. Note that the attribute information may be managed in association with the name information.

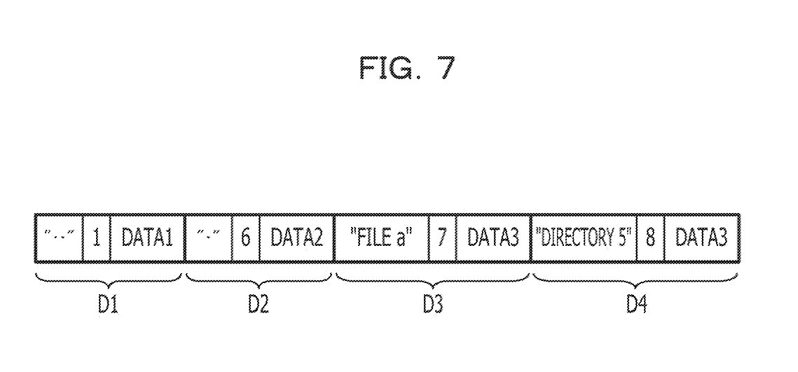

In order to realize distribution management of the name information as shown in FIG. 6A, the name information associated with each of the directories has a configuration as shown in FIG. 7.

FIG. 7 is a diagram illustrating name information associated with a directory. FIG. 7 shows the name information of the “directory 2” shown in FIG. 6A.

The name information includes data D1 associated with the parent directory 1, data D2 associated with the current directory 2, data D3 associated with the file a, and data D4 associated with the directory 5. The data includes three items including a name, a file ID, and a server ID. The name corresponds to a name of a file of a directory. Note that a name of a parent directory is represented by “..” whereas a name of a current directory is represented by “.”. This is because real values of the names of the directories are recorded in name information of parent directories corresponding to the directories. The file ID is an example of second identification information and represents an identifier of a file or a directory. The server ID is an example of first identification information and represents one of the server apparatuses 10 to which a directory or a file is assigned. The server IDs are identification information of the server apparatuses 10. Any information may be used as the server ID as long as each of the server apparatuses 10 is identified. For example, an IP address or a host name may be used as the server ID.

In this embodiment, a file or a directory is uniquely specified in accordance with a combination of the file ID and the server ID. Note that a server apparatus 10 to which a directory is assigned corresponds to one of the server apparatuses 10 which manages name information associated with the directory. Furthermore, a server apparatus 10 to which a file is assigned corresponds to one of the server apparatuses 10 which stores a body of the file.

For example, referring to the data D3, a file ID of the file a is “7” and a body of the file a is stored in one of the server apparatuses 10 corresponding to a server ID of “DATA3”. Furthermore, referring to the data D4, a file ID of the directory 5 is “8” and the directory 5 is assigned to one of the server apparatuses 10 corresponding to the server ID of “DATA 3”. Note that a plurality of directories may be assigned to a single server apparatus 10. Furthermore, no directory may be assigned to a server apparatus 10.

Referring back to FIG. 5. The monitoring unit 21 includes a receiving unit 211, a sending unit 212, and a storage unit 213. The receiving unit 211 receives a notification supplied from each of the server apparatuses 10 in a heart beat communication and stores server information included in the notification in the storage unit 213. The sending unit transmits a list of server information which is transmitted from each of the server apparatuses 10 and which is recorded in the storage unit 213 to the server apparatuses 10. By this, each of the server apparatuses 10 recognizes states of the other server apparatuses 10.

Hereinafter, a processing procedure of the file management system 1 will be described. First, a processing procedure performed when one of the server apparatuses 10 is activated will be described.

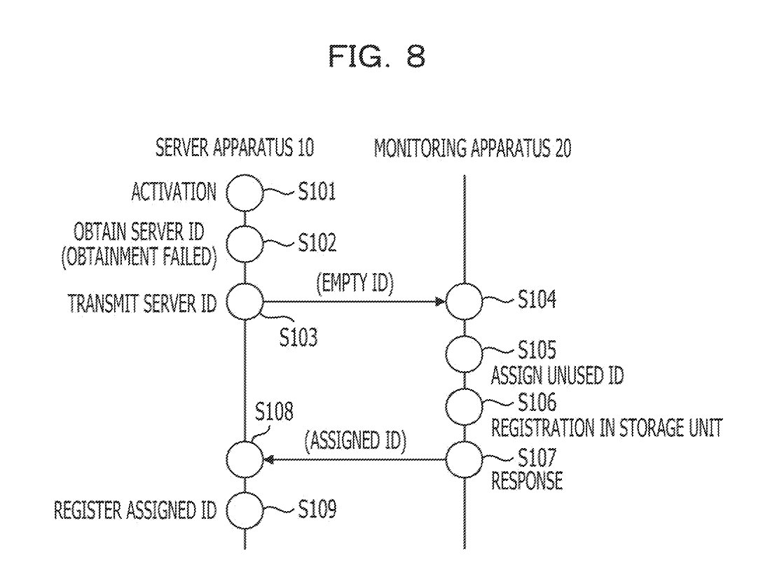

FIG. 8 illustrates a processing procedure when one of the server apparatuses 10 is newly activated. The term “one of the server apparatuses 10 is newly activated” means that one of the server apparatuses 10 is newly activated as a component of the file management system 1.

When one of the server apparatuses 10 is newly activated (in operation S101), the sending unit 115 of the server apparatus 10 attempts to obtain a server ID of the server apparatus 10 from a specified storage region of the server apparatus 10 (in operation S102). Here, the server ID is normally assigned to a server apparatus 10 which is recognized by the monitoring apparatus 20. However, since the server apparatus 10 is newly activated, the server apparatus 10 has not been recognized by the monitoring apparatus 20. Accordingly, the server ID has not been assigned to the server apparatus 10. Therefore, in operation S102, the server ID is not obtained.

The sending unit 115 specifies an empty server ID and an IP address and transmits a notification representing that the server apparatus 10 has been activated to the monitoring apparatus 20 (in operation S103). When receiving the notification (in operation S104), the receiving unit 211 of the monitoring apparatus 20 assigns an unused server ID to the server apparatus 10 in accordance with the empty server ID specified in the notification (in operation S105). The receiving unit 211 generates a new record in the storage unit 213 and records (registers) the server ID and the IP address in the record (in operation S106).

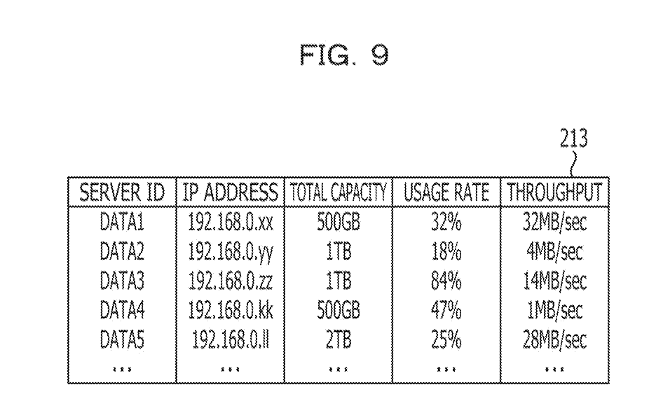

FIG. 9 is a diagram illustrating a configuration of the storage unit 213. As shown in FIG. 9, the storage unit 213 stores server IDs, IP addresses, total capacities, usage rates, throughputs, and the like of the server apparatuses 10 which are operating. The total capacities represent total capacities of the secondary storage devices 102 of the server apparatuses 10. The usage rates represent usage rates of the secondary storage devices 102. The throughputs represent latest actual communication amounts (for example, actual communication amounts in a specified period of time in the past). The total capacities, the usage rates, the throughputs, and the like are merely examples of statistical information representing the states or loads of the server apparatuses 10. Therefore, other information may be managed.

In operation S106, the server ID and the IP address are recorded in the new record. Note that, in operation S103, a total capacity, a usage rate, a throughput, and the like may be transmitted from the sending unit 115. In this case, the total capacity, the usage rate, the throughput, and the like are also recorded in the new record.

The sending unit 212 transmits the server ID as a response to the server apparatus 10 (in operation S107). Note that content of the storage unit 213 (the list of server information) may be transmitted as the response along with the server ID.

When receiving the server ID (in operation S108), the receiving unit 116 of the server apparatus 10 stores the server ID in a specified storage region as a server ID assigned to the server apparatus 10 (in operation S109). Furthermore, when receiving the list of the server information, the receiving unit 116 also stores the list in a specified storage region.

In this way, the server apparatus 10 is registered in the monitoring apparatus 20. Furthermore, the monitoring apparatus 20 has assigned the server ID to the server apparatus 10. Accordingly, the server apparatus 10 can be identifiable by the server ID in the file management system 1. Note that, when the server apparatus is to be stopped, the sending unit 115 transmits a stop notification which specifies the server ID to the monitoring apparatus 20. The receiving unit 211 of the monitoring server 20 removes the record associated with the server ID specified by the stop notification from the storage unit 213.

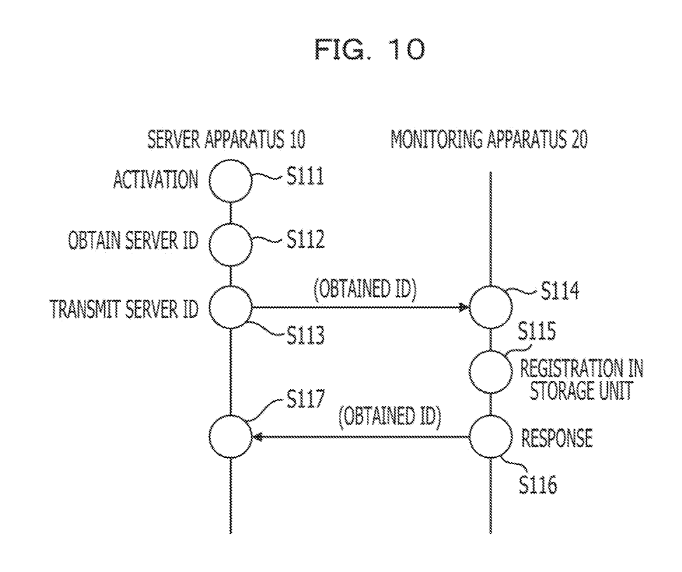

A processing procedure performed when an existing server apparatus 10 is activated will be described. FIG. 10 is a diagram illustrating a processing procedure when an existing server apparatus is activated. The term “existing server apparatus 10” means a server apparatus to which a server ID has been assigned in the past.

When the existing server apparatus 10 is activated (in operation S111), the sending unit 115 of the server apparatus 10 obtains a server ID from a specified storage region of the server apparatus 10 (in operation S112). Since the server apparatus 10 corresponds to the “existing server apparatus 10”, the server ID is normally obtained.

The sending unit 115 specifies the server ID and an IP address and transmits a notification representing the activation of the server apparatus 10 to the monitoring apparatus 20 (in operation S113). When receiving the notification (in operation S114), the receiving unit 211 of the monitoring apparatus 20 generates a new record in the storage unit 213 in accordance with the specified server ID in the notification and records (registers) the server ID and the IP address in the record (in operation S115). Note that, in operation S113, a total capacity, a usage rate, a throughput, and the like may be transmitted from the sending unit 115. In this case, the total capacity, the usage rate, the throughput, and the like are also recorded in the new record.

The sending unit 212 transmits the server ID to the server apparatus 10 as a response (in operation S116). Note that content (the list of server information) of the storage unit 213 may be transmitted as the response along with the server ID.

The receiving unit 116 of the server apparatus 10 recognizes that the server apparatus 10 has been normally registered in the monitoring apparatus 20 in accordance with the reception of the server ID (in operation S117). Note that when receiving the list of server information, the receiving unit 116 records the list in a specified storage region.

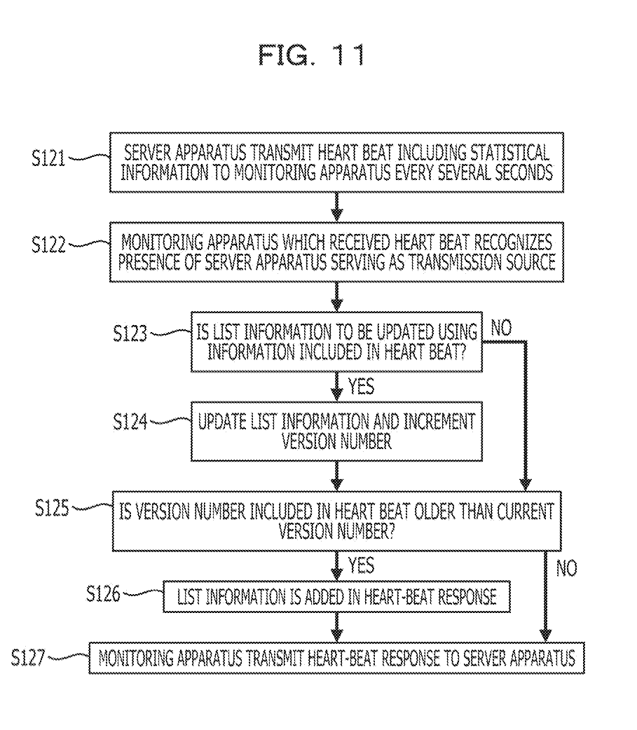

A processing procedure of a heart beat communication continuously executed after the server apparatus 10 is activated will be described. FIG. 11 is a diagram illustrating a processing procedure of a heart beat communication.

In operation S121, the sending unit 115 of the server apparatus 10 sends a heart beat to the monitoring apparatus 20 every several seconds. The receiving unit 211 of the monitoring apparatus 20 recognizes that the server apparatus 10 corresponding to a server ID included in the heart beat exists (normally operate) when receiving the heart beat (in operation S122). Note that, in this embodiment, the heart beat includes, in addition to the server ID, statistical information (a total capacity, a usage rate, a throughput, and the like) representing a state or a load of the server apparatus 10 and a version number of a list of server information stored in the server apparatus 10 serving as a heart-beat transmission source. The version number also serves as a version number of the content (that is, the list of server information) of the storage unit 213. The version number is updated in response to an update of the content of the storage unit 213.

The receiving unit 211 determines whether the storage unit 213 is to be updated in accordance with the received heart beat (in operation S123). Specifically, it is determined whether information included in the heart beat is different from information which is recorded in the storage unit 213 and which is associated with the server ID included in the heart beat.

When the determination is affirmative (in operation S123), the receiving unit 211 updates the storage unit 213 using the information included in the heart beat. Furthermore, the receiving unit 211 increments the version number of the storage unit 213 (in operation S124). Note that when the determination is negative (in operation S123), the operation in operation S124 is not executed and the process proceeds to operation S125.

The sending unit 212 determines whether the version number included in the heart beat is older than the current version number (in operation S125). When the determination is affirmative (in operation S125), the sending unit 212 incorporates the content of the storage unit 213 and the version number of the content in a response to the heart beat (in operation S126). The sending unit 212 transmits the response to the heart beat to the heart-beat transmission source (in operation S127).

As described above, in this embodiment, the version of the list of server information is managed. The heart beat includes the version number of the list of server information included in the server apparatus 10, and when the version number is older than the version number of the monitoring apparatus 20, the latest list of server information is supplied as a response. Accordingly, an amount of increase of a transmission load caused by the response to the heart beat including the list of server information can be suppressed.

Note that the list of the server information included in the response in operation S126 may be limited to the difference between the content corresponding to the version number included in the heart beat and the current content of the storage unit 213. In this case, the monitoring apparatus 20 should store the list of server information corresponding to a specified number of versions in the past. By this, the monitoring apparatus 20 can recognize the content of the list of server information corresponding to the version number specified by the heart beat and can obtain a difference between the content of the list of the server information corresponding to the version number specified by the heart beat and the latest content.

Note that the monitoring apparatus 20 removes a record of a server apparatus 10 which does not transmit a heart beat to the monitoring apparatus 20 for a specified period of time from the storage unit 213. Specifically, although omitted in FIG. 9, a date and time when the latest heart beat is received is recorded in the storage unit 213 for each server apparatus 10. The monitoring apparatus 20 automatically removes a record in which a specified period of time has been elapsed after the latest received date and time.

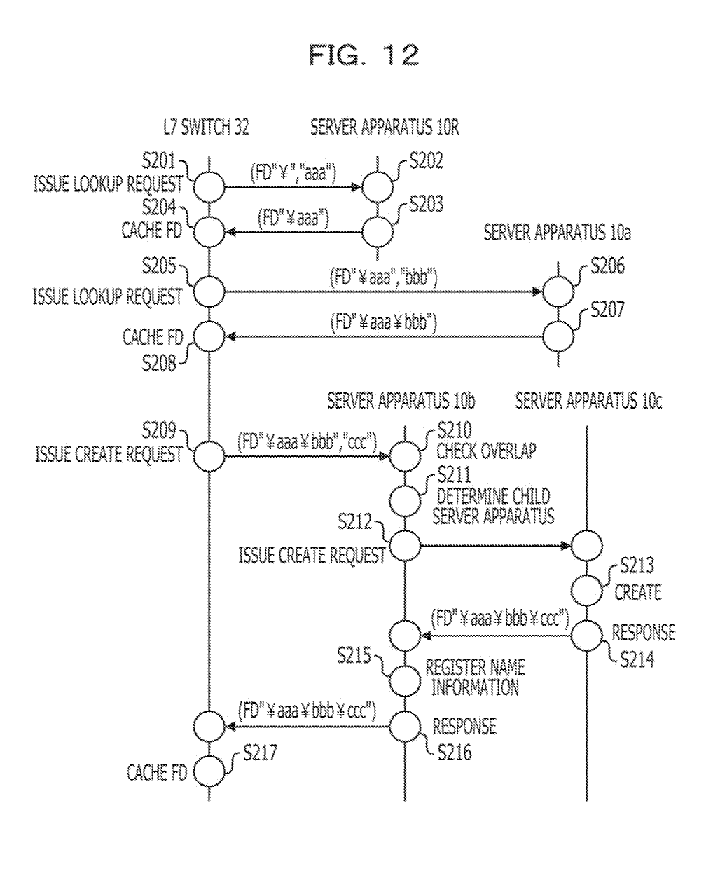

A processing procedure of a file generation process will be described. FIG. 12 illustrates a processing procedure of a file generation process. The processing procedure shown in FIG. 12 is started when the relaying unit 321 of the L7 switch 32 received a request (CREATE command) for generating a file from the client unit 31 in the client apparatus 30. A path name of a file to be generated is specified by the CREATE command. In this embodiment, a case where a generation of a file having a file name of “ccc” in a directory of “\aaa\bbb” is requested will be described. Therefore, “\aaa\bbb\ccc” is specified as a path name. Furthermore, in an initial state in FIG. 12, content of the storage unit 323 is empty.

In this embodiment, directories and files are assigned to the plurality of server apparatuses 10 in a distribution manner. Therefore, the relaying unit 321 requests the obtaining unit 322 to obtain an FD of the directory “\aaa\bbb” serving as a destination of generation of the file “ccc”. The obtaining unit 322 obtains a target FD by tracing layers of the path “\aaa\bbb” from the root directory “\” one by one.

Specifically, in operation S201, the obtaining unit 322 transmits a LOOKUP request (request for obtaining an FD) associated with a directory “aaa” which is located immediately below the root directory to a server apparatus 10R to which the root directory (“\”) is assigned. That is, in this embodiment, in the obtaining unit 322, identification information (a server ID, an IP address, and the like) of the server apparatus 10R to which the root directory has been set in advance. Accordingly, in operation S201, the LOOKUP request is supplied to the server apparatus 10R in accordance with the identification information of the server apparatus 10R which is a set value. Note that, when the server ID of the server apparatus 10R has been set as the identification information of the server apparatus 10R, the obtaining unit 322 transmits an inquiry of an IP address corresponding to the server ID to the monitoring apparatus 20. Alternatively, the L7 switch may periodically obtain information on the list of the server apparatuses 10 from the monitoring apparatus 20 and record the information in a storage device included in the client apparatus 30.

Note that other directories or other files may be assigned to the server apparatus 10R to which the root directory is assigned. Furthermore, the LOOKUP request is a standard request in the NAS protocol.

In the storage unit 118 included in the server apparatus 10R, at least name information (refer to FIG. 7) associated with the root directory is stored. That is, names, file IDs, and server IDs of files or directories which are located immediately below the root directory have been stored. Accordingly, in response to the LOOKUP request, the replying unit 111 of the server apparatus 10R obtains data corresponding to the directory “aaa” from the name information and generates an FD of the directory “aaa” on the basis of the data (in operation S202).

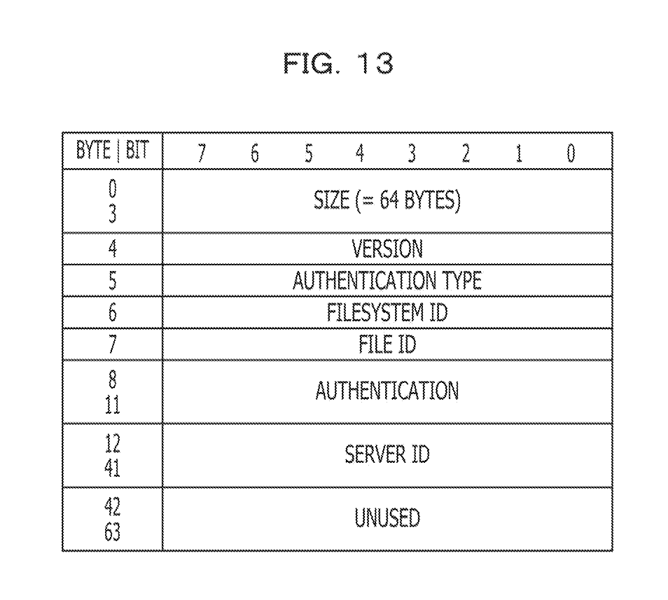

FIG. 13 is a diagram illustrating a configuration of a file descriptor according to this embodiment. FIG. 13 shows arrangement of data items included in an FD of 64 bytes in which bits are represented in a horizontal direction and bytes are represented in a vertical direction.

In this embodiment, a standard format of an FD used in the NFS is basically used, and expansion is realized by embedding a server ID of a server apparatus 10 to which a directory or a file corresponding to the FD is assigned in an unused region of the FD. That is, although bytes after the 12th byte are unused regions in the standard FD, a server ID is recorded in a region corresponding to 30 bytes from the 12th byte to the 41st byte in this embodiment. A server ID is recorded in an FD so that the L7 switch 32 identifies the server apparatus 10 to which a file of a directory corresponding to the FD is assigned in accordance with the FD. The number of bytes of the region recording the server ID may be appropriately changed in accordance with the number of bytes of the server ID. The other items are substantially the same as those of the standard FD, and therefore, descriptions thereof are omitted. Furthermore, even when an NAS protocol other than the NFS, such as a CIFS or the like, is used, a server ID is similarly embedded in an unused region of an FD or a file handle.

Accordingly, in operation S202, an FD in which a file ID and a server ID included in the data associated with “aaa” obtained from the name information of the root directory are recorded in a specified position is generated. As shown in FIG. 13, the file ID is recorded in the seventh byte.

Note that the FD is data which is opened to (presented for) the client unit 31. Note that the server ID is embedded in an unused region, and the other existing data items are not changed. Therefore, the server ID is hidden from the client unit 31. Accordingly, the client unit 31 is not affected (for example, a modification of a source code is not required) even though the server ID is embedded in the FD.

The replying unit 111 transmits the generated FD (FD corresponding to “\aaa”) to the obtaining unit 322 as a response in operation S203. The obtaining unit 322 associates the FD which is the response with the path name (“\aaa”) of the directory corresponding to the FD and records the FD in the storage unit 323 in operation S204.

The obtaining unit 322 extracts the server ID from the FD which is the response, specifies the FD and a directory name “bbb”, and transmits a LOOKUP request to one of the server apparatuses 10 (the server apparatus 10a in this embodiment) corresponding to the server ID (in operation S205). Note that an IP address of the server apparatus 10a is obtained from the list information of the server apparatuses 10 recorded in the storage unit 213 using the server ID as a key. Taking performance of a file operation into consideration, the list information may be obtained by the client apparatus 30 at a specified time such as a time when the client apparatus 30 is activated and may be recorded (stored) in a memory or an secondary storage device of the client apparatus 30. In this way, in the client apparatus 30, use of a network communication is reduced when an IP address is to be obtained using the server ID included in the FD.

The replying unit 111 of the server apparatus 10a obtains data corresponding to the directory “bbb” using the name information of the directory “\aaa” corresponding to the file ID and the server ID recorded in the FD in response to the LOOKUP request. The replying unit 111 generates the FD in which the server ID and the file ID included in the data are recorded (in operation S206). The replying unit 111 transmits the generated FD to the obtaining unit 322 as a response (in operation S207). The obtaining unit 322 associates the FD transmitted as the response with the directory path name (“\aaa\bbb”) corresponding to the FD and records the FD in the storage unit 323 (in operation S208).

In this way, the FD of the target directory is obtained. The relaying unit 321 obtains an IP address corresponding to the server ID of the FD from the server list. The relaying unit 321 transmits a file generation request (CREATE request) to a target corresponding to the IP address (the server apparatus 10b in this embodiment) (in operation S209). The file generation request specifies the FD and the file name “ccc” of the file to be generated.

The selecting unit 112 of the server apparatus 10b refers to the name information of the directory corresponding to the FD specified by the generation request and determines whether data associated with a file or a directory which has the name “ccc” is included in the name information (in operation S210). That is, it is determined whether a file or a directory which has the name “ccc” has been generated below “\aaa\bbb”. When a file or a directory which has the name “ccc” is included in the name information, an error is supplied as a response.

When a file or a directory which has the name “ccc” is not included in the name information, the selecting unit 112 determines (selects) one of the server apparatuses 10 (hereinafter referred to as a “child server apparatus”) serving as a destination of generation of the file to be generated (in operation S211). For example, the selecting unit 112 selects a child server apparatus to which a comparatively small load is currently applied according to statistic information (state information) included in the list of server information stored in the server apparatus 10b. For example, one of the server apparatuses 10 which has the largest amount of space is selected as the child server apparatus with reference to the total capacities and the usage rates. Alternatively, one of the server apparatuses 10 which corresponds to the smallest throughput (the smallest amount of a communication immediately before a current communication) may be selected as the child server apparatus. Furthermore, one of the server apparatuses 10 to which a parent directory is assigned may be selected as the child server apparatus. Furthermore, the child server apparatus may be selected in a random manner. Moreover, the child server apparatus may be selected in another way.

The transfer unit 113 transfers the file generation request to the server apparatus 10 selected as the child server apparatus (a server apparatus 10c in this embodiment) (in operation S212). Accordingly, the generation request specifies the FD and the file name “ccc” which are substantially the same as those in operation S209.

The operation unit 114 of the server apparatus 10c generates a file specified by the generation request in the storage unit 117 included in the server apparatus 10c (in operation S213). When the file is generated, an FD which records a file ID of the file is also generated. The operation unit 114 records the server ID of the server apparatus 10c in the FD. The operation unit 114 transmits the generated FD (that is, an FD corresponding to “\aaa\bbb\ccc”) to the server apparatus 10b as a response to the file generation request (in operation S214).

The transfer unit 113 of the server apparatus 10b additionally registers data associated with the file “ccc” in the name information of the directory “\aaa\bbb” in accordance with the FD transmitted as the response (in operation S215). Specifically, the file name “ccc” received in operation S210 is associated with the file ID and the server ID included in the FD transmitted as the response in operation S214 and stored in the name information.

Note that, when the server apparatus 10b is selected as the child server apparatus in operation S211, the operation in operation S212 is not executed. In this case, the operation unit 114 of the server apparatus 10b executes operations substantially the same as those in operation S213 and operation S214.

The transfer unit 113 transmits the FD corresponding to “\aaa\bbb\ccc” to the L7 switch 32 as a response (in operation S216). The relaying unit 321 of the L7 switch 32 associates the FD transmitted as the response with the path name “\aaa\bbb\ccc” of the generated file and records the FD in the storage unit 323 (in operation S217). The replaying unit 321 transmits the FD as a response to the client unit 31 serving as the source of the file generation request. The client unit 31 can transmit a request for performing writing to the file “\aaa\bbb\ccc” and the like to the replaying unit 321 using the FD. In this case, the relaying unit 321 transmits the request for performing writing to the file to one of the server apparatuses 10 corresponding to the server ID recorded in the FD. That is, if the FD has been obtained, the request is directory transmitted to one of the server apparatuses 10 having a file corresponding to the FD. Therefore, when the FD has been obtained, deterioration of performance caused by distributed name information is negligible. An IP address corresponding to the server ID is obtained from the server list, for example.

Note that, although the file generation process has been described with reference to FIG. 12, a directory generation process is executed in substantially the same procedure.

Here, in this embodiment, although the file generation request in operation S209 and the file generation request in operation S212 may be the same message, different processing procedures are performed in the server apparatuses 10b and 10c. This is because, even if file generation requests correspond to substantially the same message, the server unit 11 changes a process to be executed in accordance with a determination as to whether a directory corresponding to an FD specified by a generation request is assigned to the server apparatus 10. Specifically, in a case where a directory corresponding to an FD specified by a generation request has been assigned to a server apparatus 10, a processing procedure substantially the same as that of the server apparatus 10b is executed. On the other hand, in a case where a directory corresponding to an FD specified by a generation request has not been assigned to a server apparatus 10, a processing procedure substantially the same as that of the server apparatus 10c is executed. The determination as to whether a directory corresponding to an FD specified by a generation request has been assigned is performed in accordance with a determination as to whether name information in which a file ID and a server ID recorded in the FD are registered as data of a current directory has been recorded in the storage unit 118 of the server apparatus 10.

Alternatively, in this embodiment, a result of the determination as to whether a directory corresponding to an FD specified by a generation request has been assigned is substantially the same as a result of a determination as to whether the generation request has been received from the L7 switch 32. Accordingly, the process to be performed in response to the generation request may be changed in accordance with the latter determination result. In this case, if an IP address of a transmission source of the generation request has not been recorded in the storage unit 213, it is determined that the generated request has been transmitted from the L7 switch 32.

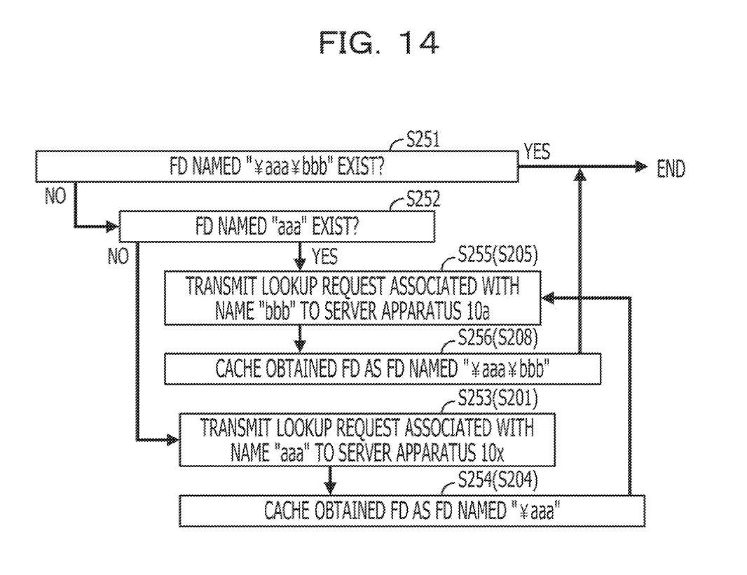

The process performed by the obtaining unit 322 shown in FIG. 12 will be described in detail. FIG. 14 is a diagram illustrating a processing procedure of a process of obtaining a file descriptor.

In operation S251, the obtaining unit 322 determines whether an FD corresponding to the directory “\aaa\bbb” which is required to be obtained by the relaying unit 321 has been recorded in the storage unit 323. When the FD has been recorded in the storage unit 323, the obtaining unit 322 outputs the FD to the relaying unit 321.

When the FD has not been stored in the storage unit 323, the obtaining unit 322 determines whether an FD corresponding to the directory “\aaa” which is an upper layer of the directory “\aaa\bbb” by one layer has been recorded in the storage unit 323 (in operation S252). That is, searching is performed on cached FDs by tracing the directory layers one by one. When the FD corresponding to the directory “\aaa” has not been recorded in the storage unit 323, the obtaining unit 322 transmits a LOOKUP request associated with the directory “aaa” located below the root to a server apparatus 10× to which the root directory is assigned (in operation S253). Note that, in FIG. 14, operation numbers included in brackets correspond to the operation numbers shown in FIG. 12.

The obtaining unit 322 associates the FD transmitted from the replying unit 111 of the server apparatus 10× as a response with the path name (“\aaa”) of the directory corresponding to the FD and records the FD in the storage unit 323 (in operation S254).

After operation S254 or after it is determined that the FD corresponding to “\aaa” has been recorded in the storage unit 323, the obtaining unit 322 specifies the FD and transmits a LOOKUP request associated with the directory “bbb” to the server apparatus 10a corresponding to the server ID recorded in the FD corresponding to “\aaa” (in operation S255). The obtaining unit 322 associates an FD transmitted from the replying unit 111 of the server apparatus 10a as a response with the path name (“\aaa\bbb”) of the directory corresponding to the FD and stores the FD in the storage unit 323 (in operation S256). The obtaining unit 322 outputs the FD to the relaying unit 321.

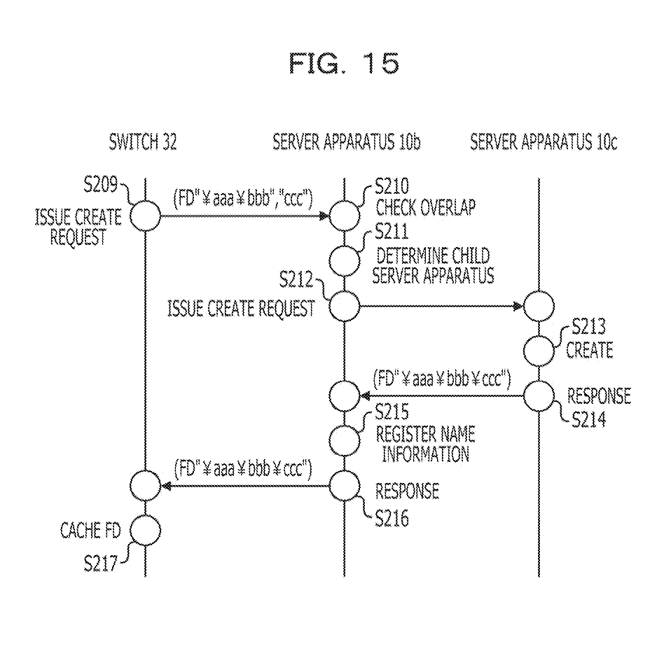

The FD obtained as described above is cached by the storage unit 323. Furthermore, it is determined whether the target FD has been recorded in the storage unit 323, and when the determination is affirmative, the FD is used. Therefore, when the FD corresponding to the directory “\aaa\bbb” has been recorded in the storage unit 323, a processing procedure shown in FIG. 15 is used instead of the processing procedure shown in FIG. 12.

FIG. 15 is a diagram illustrating a processing procedure of a file generation process performed when a file descriptor of a parent directory has been cached. In FIG. 14, operations that are substantially the same as those shown in FIG. 12 are denoted by operation numbers the same as those shown in FIG. 12 and descriptions thereof are omitted.

When FIG. 15 is compared with FIG. 12, FIG. 15 is different from FIG. 12 in that executions of the operations in operation S201 to operation S208 are not required in FIG. 15. That is, a process of searching for an FD corresponding to the directory “\aaa\bbb” is not required.

As described above, since the FD has been cached, frequency of issuance of a LOOKUP request can be reduced. As a result, possibility of deterioration of performance caused by distributed name information can be reduced. Note that a capacity of the storage unit 323 is appropriately determined in accordance with a specification of the apparatus which is actually used. Furthermore, a known technique (FIFO (First-In First-Out), LRU (Least Recently Used), or the like) is used in an algorithm for determining an FD to be discarded when an overflow of the cache occurred.

Note that, although generation of a file is described in the foregoing description, the same processing procedure is basically executed for writing (WRITE) and reading (READ). Specifically, the L7 switch 32 transmits a writing request or a reading request to one of the server apparatuses 10 which corresponds to a server ID recorded in an FD of a file to be written or a file to be read.

As described above, according to the file management system 1 of this embodiment, a first server apparatus 10 which received a file generation request instructs a second server apparatus 10 to generate a file and register a server ID and a file ID corresponding to the file in name information of directories assigned to the first server apparatus 10. Since this operation is performed by each of the server apparatuses 10, name information and file bodies are managed by the plurality of server apparatuses 10 in a distributed manner. As a result, a conventional meta server is not required and various constraints caused by presence of the meta server can be avoided. Specifically, scalability of the file management system 1 can be improved. That is, when compared with a case where a meta server is used, a larger number of (theoretically, an infinite number of) server apparatuses 10 can be integrated.

Furthermore, occurrence of bottle neck caused by concentrated accesses to a meta server can be avoided. Specifically, since name information is managed in a distributed manner, distributed name information can be accessed in parallel and parallel operation of files or directories can be improved. The parallel operation becomes pronounced as the number of server apparatuses 10 is increased.

Furthermore, the L7 switch 32 solves a problem of the distributed name information and provides with a communication interface the same as the conventional NAS protocol to the client unit 31. That is, the L7 switch 32 hides the plurality of server apparatuses 10 and the file management system of the plurality of server apparatuses 10. Accordingly, the conventional NAS client unit 31 can be easily migrated to the file management system 1 of this embodiment.

Furthermore, since the conventional NAS protocol can be used as a protocol between the L7 switch unit 32 and the server apparatuses 10, amounts of change of the server apparatuses 10 can be reduced.

Note that, in this embodiment, when a file is generated, a process which is not included in a conventional process, such as a process of transferring a generation request from one of the server apparatuses 10 to one of the other server apparatuses 10, is generated. However, after the file is generated, the file can be directory accessed in accordance with the server ID included in an FD. Furthermore, since frequency in use of a file generation command is low among various commands associated with a file operation (approximately 1%), it is highly unlikely that an increase of the number of processing operations in the file generation process considerably affects entire performance.

As described above, the embodiment of the present invention has been described in detail. According to the disclosed technique, flexibility of a file distribution management can be improved. The present invention is not limited to the specific embodiment and various modifications and alterations may be made.

All examples and conditional language recited herein are intended for pedagogical purposes to aid the reader in understanding the principles of the invention and the concepts contributed by the inventor to furthering the art, and are to be construed as being without limitation to such specifically recited examples and conditions. Although the embodiments of the present invention have been described in detail, it should be understood that the various changes, substitutions, and alterations could be made hereto without departing from the spirit and scope of the invention.

What is claimed is:

1. A file management system comprising:
a first computer; and
a second computer;
wherein the first computer comprises:
a storage unit to store information about a first directory that includes identification information of the second computer that store information about a second directory or a file under the first directory; and
a replying unit to reply, when a request for looking-up information about the second directory or the file is received, with the identification information of the second computer stored in the storage unit.

2. The file management system according to claim 1, wherein the first computer further comprises a transfer unit to transfer, when the first computer receives a request for generating a file in the second directory, the request to the second computer.

3. The file management system according to claim 2, wherein the second computer comprises a selecting unit to select a computer of the computers, when the second computer receives the request.

4. The file management system according to claim 3, further comprising a monitoring apparatus that receives status information from each of the computers, and sends a list of the status information of the computers, wherein the selecting unit selects a computer based on the list of the status information.

5. A computer-readable, non-transitory medium storing a file management program for causing a first computer of a plurality of computers storing files to execute a procedure, the procedure comprising:
storing information about a first directory that includes identification information of a second computer that stores information about a second directory or a file under the first directory in a storage unit; and
when a request for looking-up information about the second directory or the file is received, replying with the identification information of the second computer stored in the storage unit.

6. The medium according to claim 5 storing the file management program for causing the first computer to execute the procedure, the procedure further comprising transferring, when the first computer receives a request for generating a file in the second directory, the request to the second computer.

7. The medium according to claim 6 storing the file management program for causing the second computer to execute the procedure, the procedure comprising selecting a computer of the plurality of computers, when the second computer receives the request.

8. A method for file management, the method comprising:
storing information about a first directory that includes identification information of a second computer that stores information about a second directory or a file under the first directory in a storage unit of a first computer; and
when a request for looking-up information about the second directory or the file is received, replying with the identification information of the second computer stored in the storage unit, by the replying unit of the first computer.

9. The method according to claim 8 further comprises transferring, when the first computer receives a request for generating a file in the second directory, the request to the second computer.

10. The method according to claim 9 further comprises selecting a computer of a plurality of computers, when the second computer receives the request, by the selecting unit of the second computer.

11. A file management system comprising:
a memory;
a processor;
a communication interface;
wherein the memory stores information about a first directory that includes identification information of a second computer that stores information about a second directory or a file under the first directory;
wherein the processor reads, when a request for looking-up information about the second directory or the file is received, the identification information of the second computer stored in the memory; and
wherein the communication interface sends the identification information read by the processor.
